(19) United States
(12) Patent Application Publication
(10) Pub. No.: US 2008/0012165 A1
(43) Pub. Date: Jan. 17, 2008

(54) Internal Vibrator with a Measuring System

(75) Inventors: Gunter Kunze, Freital-Weissig (DE); Georg Sick, Feldafing (DE); Stefan Graul, Worlitz (DE)

Correspondence Address: BOYLE FREDRICKSON S.C., 840 North Plankinton Avenue, MILWAUKEE, WI, 53203, US

(73) Assignee: WACKER CONSTRUCTION EQUIPMENT AG, Munchen (DE)

(21) Appl. No.: 11/777,516

(22) Filed: Jul. 13, 2007

Related U.S. Application Data
(63) Continuation of application No. 09/937,331, filed on Feb. 4, 2002.

(30) Foreign Application Priority Data
Mar. 23, 1999 (DE) 199 13 077.9
Mar. 10, 2000 (EP) PCT/EP00/02138

(51) Int. Cl. B28B 1/00

(52) U.S. Cl. 264/40.7; 425/424

(57) ABSTRACT

An internal vibrator for vibrating a plastic material such as concrete has a measuring device for determining certain operating parameters, e.g. for measuring the motion of a vibrating cylinder in which a device for generating vibrations is accommodated or a power consumption or speed of an electromotor belonging to the device for generating vibrations. Two acceleration sensors that are able to detect the acceleration values for the vibrating cylinder in the concrete to be vibrated are also suitable since this enables conclusions to be made about the result of the vibration. The measuring values of the acceleration sensor and a power measuring device are evaluated by an evaluation circuit and can be conveyed to the user via a display.

### CROSS REFERENCE TO RELEATED APPLICATION

This application is a continuation of U.S. patent application Ser. No. 09/937,331 filed on Sep. 21, 2001, the entirety of which is expressly incorporated by reference herein.

### BACKGROUND OF THE INVENTION

1. Field of the Invention

This invention pertains to a poker vibrator.

2. Description of the Related Art

It is well known that after it is poured into a form, fresh concrete has to be densified in order to attain a specific density and to eliminate the presence of gas pores, or so-called “gravel nests”. Even at just a 10% reduction in the density of the concrete, the compressive strength is half as a result. However, densifying the concrete too much can lead to separation of the concrete, resulting in zonal enrichment of cement.

Larger concrete fills are commonly densified manually using vibrators or agitators, such as tubular or rod-type vibrators. These types of vibrators are called poker vibrators, which are equipped with an eccentric weight driven by an electric motor and located inside of a vibration flask that is plunged into the fresh concrete. This arrangement results in oscillations that densify the concrete. Whereas concrete is subject to a variety of strict quality controls, the proper densification of the concrete depends considerably on the individual abilities of the operators of the poker vibrator. However, since the individual abilities of different operators can of course be very different, the quality of densification can deviate widely, which results in some cases to an unsatisfactory density and thus to inadequate concrete strength.

The variety of factors influencing the densification has already been illustrated in numerous studies. Decisive factors are the m·r value of the eccentric weight (mass×radius), the acceleration of the vibration flask holding the eccentric weight and the drive motor, the frequency, the consumed electrical power, the amplitude of the path and the energy of the individual impact.

In DE-OS-39 01 893, a poker vibrator is described with a vibration unit and a switching unit separated by an elastic connection. In this vibrator is a measurement device to detect the RPM of an electric motor powering an oscillator. The measurement device is part of an RPM control unit that is used to control the rotational speed of the electric motor such that it follows a preset value.

In DE-A-2 162 201, a poker vibrator is described in which an electric motor driving an eccentric mass is equipped with a motor protection switch that can be activated by a temperature sensor located at the motor windings.

From DE-A-195 42 868, a vibrator apparatus is known that is used in the manufacturing of formed concrete parts in which two external vibrators are provided with their own acceleration detectors. The vibration forces applied by the external vibrators onto a vibrating table [plate] are detected by the acceleration detectors and processed further in the form of measured signals. Using the measured signals and stored comparison values, a prognosis on the product quality to be expected of the formed parts can be generated.

From GB-A-1097651, a poker vibrator is known in which the power consumption of an electric motor that drives an eccentric mass is used as an indication for the degree of densification of the concrete to be densified.

### OBJECT OF THE INVENTION

The objective of this invention is to provide a poker vibrator that gives the operator information enabling him to estimate the quality of his densification work independent of his individual abilities.

This objective is met by a poker vibrator apparatus in accordance with the present invention.

The poker vibrator according to the present invention has a measurement device to detect at least one operating parameter of the poker vibrator apparatus. This operating parameter is a parameter of the group consisting of: the motion of the vibration unit, the oscillatory amplitude of the vibration unit, its oscillatory frequency, the RPM of the electric motor, the electrical excitation frequency of the electric motor and the winding temperature of a stator of the electric motor. Furthermore, an evaluation circuit is provided through which a signal is produced from the measured value, and thus from a change in the operating parameter, that corresponds to a change in the densified state of the material.

It has been shown that the above operating parameters correlate to a change in density of the concrete so that from a change in the operating parameter, conclusions can be drawn about the densification effect of the poker vibrator.

The measured values provided by the measurement device are evaluated by the evaluation circuit. Evaluation algorithms are used in the process so that from a change in the operating parameter, conclusions can be drawn about a change in the state of densification of the material to be densified.

As already shown, the densification effect depends on numerous parameters, of which only a few are measurable, however. In addition to the acceleration of the vibration unit in the concrete, which is commonly produced in the form of a vibration flask, there is the electrical power consumed by the drive motor and its RPM, as well as unchanging parameters such as the m·r value and the mass of the vibration flask. These defined operating parameters partially overlap one another. Thus, for example, conclusions on the motion of the vibration unit, in particular its acceleration, can be made from the oscillatory amplitude and the oscillatory frequency of the vibration unit. The power consumption of the electric motor is determined essentially from the flow of current—assuming a constant voltage.

It is advantageous that the measurement device is fed through the evaluation circuit.

An especially advantageous embodiment form of the invention is characterized in that the measurement device includes at least one motion measurement device provided in the vibration unit. By locating the motion measurement device, which is preferred to be an acceleration detector, within the vibration unit, the motion of the vibration unit can be detected directly, which allows conclusions to be drawn on the densification effect. Provided that the acceleration of the vibration unit is measured, the speed and the path of motion of the vibration flask can also be determined through integration.

It is an advantage that the evaluation circuit is provided within the switching unit, which is separate from the vibration unit, and that it feeds the motion measurement device and evaluates its signals. Since the switching unit is only connected to the vibration unit elastically, damaging influences on the electronics of the evaluation circuit caused by the oscillations produced by the vibration unit are prevented.

It is an advantage that the switching unit is combined with a power switch and a frequency converter within a single switch housing. The frequency converter makes it possible to change the mains frequency into a higher frequency required for the drive motor inside the vibration flask.

If two acceleration detectors are provided in the vibration unit and their measurements are taken perpendicular to one another and to a longitudinal axis of the vibration unit, the path that the oscillations take in all directions perpendicular to the longitudinal axis can be detected.

In another embodiment form of the invention, the measurement device includes a power measurement device coupled to the evaluation circuit to determine the electrical power consumed by the oscillator, i.e. by the drive motor. The power measurement, can for example, be done by measuring the current consumed by the electric motor. This also allows conclusions to be drawn concerning the densification results.

If, in addition, the acceleration detector is also provided inside the vibration unit, the values measured by the power measurement device and those of the acceleration detector can be processed together using suitable algorithms. This makes the measurement results that much more precise.

Using the evaluation circuit, a signal can be sent to the operator through an optical and/or acoustic display if his densification work has reached the optimum range. Conversely, if the required densification has not been reached, a warning signal can be given off. If the measurement results are determined to be outside of a prescribed range, the poker vibrator device can also automatically go into a Safe Standby mode or be otherwise inactivated

The objective of this invention is to provide a poker vibrator that enables the operator—independent of his individual abilities—to estimate the quality of his densification work.

According to the invention, this objective is met by a poker vibrator apparatus with the features of the simultaneous patent claims 1 or 9. Advantageous developments of the invention are found in the dependent claims.

The poker vibrator according to the invention as cited in claim 1 has a measurement device to detect at least one operating parameter of the poker vibrator apparatus. This operating parameter is a parameter of the group consisting of: the motion of the vibration unit, the oscillatory amplitude of the vibration unit, its oscillatory frequency, the power consumption of the electric motor, electrical excitation frequency of the electric motor and the winding temperature of a stator of the electric motor.

It has been shown that the above operating parameters, as well as the RPM of the electric motor, correlate with a change in density of the concrete so that from a change in the operating parameters, conclusions can be drawn about the densification effect of the poker vibrator.

An advantage is that the measurement device is operated from an evaluation circuit.

In the poker vibrator device of the present invention, there is a measurement device to detect the RPM of the electric motor. The measured values provided by the measurement device are evaluated by an evaluation circuit. Evaluation algorithms are used in the process so that from a change in the RPM of the electric motor, conclusions can be drawn on a change in the state of densification of the material to be densified.

As already shown, the densification effect depends on numerous parameters, of which only a few are measurable, however. In addition to the acceleration of the vibration unit in the concrete, which is commonly produced in the form of a vibration flask, there is the electrical power consumed by the drive motor and its RPM, as well as unchanging parameters such as the m·r value and the mass of the vibration flask. These defined operating parameters partially overlap one another. Thus, for example, conclusions on the motion of the vibration unit, in particular its acceleration, can be made from the oscillatory amplitudes and the oscillatory frequency of the vibration unit. The power consumption of the electric motor is determined essentially from the flow of current—assuming a constant voltage.

An especially advantageous embodiment form of the invention is characterized in that the measurement device includes at least one motion measurement device provided in the vibration unit. By locating the motion measurement device, which is preferred to be an acceleration detector, within the vibration unit, the motion of the vibration unit can be detected directly, which allows conclusions to be drawn on the densification effect. Provided that the acceleration of the vibration unit is measured, the speed and the path of motion of the vibration flask can also be determined through integration.

It is an advantage that the evaluation circuit is provided within the switching unit, which is separate from the vibration unit, feeding the motion measurement device and evaluating its signals. Since the switching unit is only connected to the vibration unit elastically, damaging influences on the electronics of the evaluation circuit caused by the oscillations produced by the vibration unit are prevented.

It is an advantage that the switching unit is combined with a power switch and a frequency converter within a single switch housing. The frequency converter makes it possible to change the mains frequency into a higher frequency required for the drive motor inside the vibration flask.

If two acceleration detectors are provided in the vibration unit and their measurements are taken perpendicular to one another and to a longitudinal axis of the vibration unit, the path that the oscillations take in all directions perpendicular to the longitudinal axis can be detected.

In another embodiment form of the invention, the measurement device includes a power measurement device coupled to the evaluation circuit to determine the electrical load consumed by the oscillator, i.e. by the drive motor. The power measurement, can for example, be done by measuring the current consumed by the electric motor. This also allows conclusions to be drawn concerning the densification results.

If, in addition, the acceleration detector is provided inside the vibration unit, the values measured by the power measurement device and those of the acceleration detector can be processed together using suitable algorithms. This makes the measurement results that much more precise.

Using the evaluation circuit, a signal can be sent to the operator through an optical and/or acoustic display if his densification work has reached the optimum range. Conversely, if the required densification has not been reached, a warning signal can be given off. If the measurement results are determined to be outside of a prescribed range, the poker vibrator device can also automatically go into a Safe Standby mode or be otherwise inactivated.

This and other advantages and features of the invention are explained below with the help of the following exemplary specific embodiment illustrated in the drawings in which:

### BRIEF DESCRIPTION OF THE DRAWINGS

FIG. 1 is a schematic plan view of a poker vibrator for mixing concrete; and

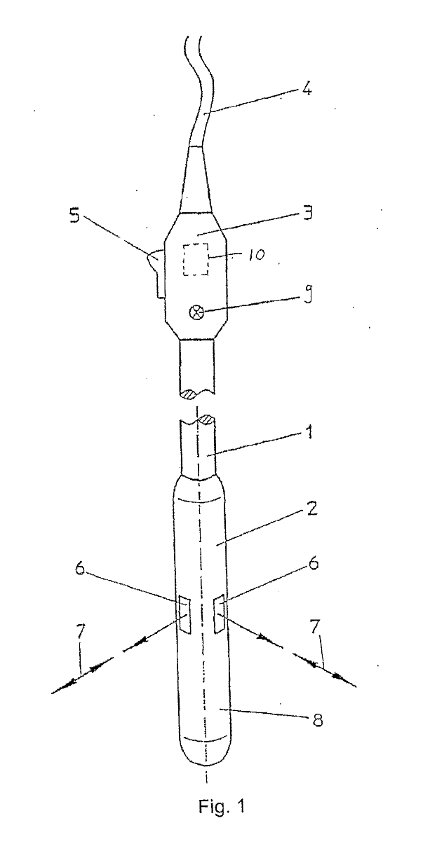

FIG. 2 shows a schematic plan view switch housing of the poker vibrator of FIG. 1 according to the present invention.

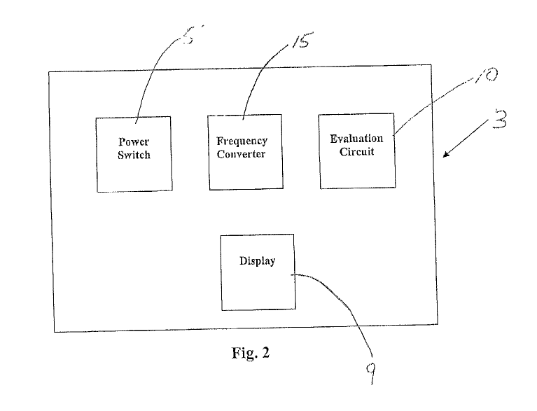

### DETAILED DESCRIPTION OF THE PREFERRED EMBODIMENT

The tubular vibrator has a vibration flask 2 held by a protective tube 1. On the other end of the protective tube 1, sometimes with a length of a few meters, is a switch housing 3 that serves as a switching unit. A power cable 4 extends from this housing.

The poker vibrator is held by the operator at the tube 1, which is for operation and protection. Conversely, in the handle or rod-type vibrators mentioned above, a handle is provided for operation. The switch housing 3 can be integrated into this handle.

In the vibration flask 2 that serves as a vibration unit, there is an electric motor that drives, in a known fashion, an eccentric weight that is also located inside the vibration flask 2. The desired oscillations of the vibration flask 2 are produced in this way.

In addition to a power switch 5, there is a frequency converter 15 provided in the switch housing 3 which converts the electrical mains frequency fed through the power cable 4 to a higher frequency value required to operate the electric motor. Values of 200 Hertz are common.

Since the existing tubular vibrator is essentially known, its detailed description is not necessary.

In the vibration flask 2 of the tubular vibrator according to the invention, there are two acceleration detectors 6 serving as motion measurement devices located in such a way that their measurement directions 7 are perpendicular to a longitudinal axis 8 of the vibration flask 2. In addition, the two measurement directions 7 are perpendicular to one another so that the acceleration detectors can detect six (6) oscillations in a plane perpendicular to the longitudinal axis 8.

The acceleration detectors 6 are miniaturized components, such as can be found in the automobile technology for airbag controls, or vehicle stabilization systems. This allows the acceleration detectors 6 to be built very small so that the vibration flask 2 does not have to be fundamentally redesigned in order to accept the acceleration detectors 6.

In the switch housing 3, there is an evaluation circuit 10, which is connected to the acceleration detectors 6 and which thus does not just feed them with electrical energy, but also detects and evaluates the signals sent from the acceleration detectors.

Evaluation algorithms are stored in the evaluation circuit used to evaluate the measurement results that are supplied by the acceleration detectors 6. A memory can also be provided for this purpose to store certain characteristic fields or algorithms. The evaluation algorithms and characteristic fields can be established by an expert by means of preliminary tests to relate the corresponding parameters to the densification results.

The evaluation circuit 10 can be implemented in an advantageous fashion in the form of a neural network or a fuzzy logic system in order to process the measurement signals further in real time and to enable a certain level of adaptability for the device. Of course, the evaluation electronics can also be set up using classical control and regulatory components.

Other than in the switch housing 3, the evaluation circuit 10 can also be kept directly in the vibration flask 2 or at another location, whereby the switch housing 3 has the advantage in that it is free of oscillations for the most part, which protects the electronic components.

To increase the measurement precision, it is advantageous to include a power measurement device, also kept in the switch housing 3. This power measurement device determines the electrical power consumed by the oscillator, i.e. by the electric motor. This consumed power is likewise a criterion that has an influence on the densification effect of the vibrator. The power measurement device is connected to the evaluation circuit 10 in which the measured signals are processed using suitable algorithms.

If the evaluation circuit determines that the measured parameters are within a certain range or take a certain path indicating that the densification result is optimum at a particular point in time, it sends an optical signal to the operator through a display 9. The display 9 can, for example, be implemented using a red and a green lamp, wherein in case of insufficient densification effect, the red lamp lights, and if the desired densification result is attained, the green lamp lights. Another display possibility is to control a light bar whose length or brightness varies depending on the densification result. Moreover, it is also possible to inform the operator acoustically concerning the current state of the process. Of course, numerous other possibilities are conceivable to report or further apply the results of the evaluation of the measured parameters. However, it must be noted that the poker vibrator is usually subject to tough construction site conditions so that a certain robustness should be strived for in any case.

In another, especially advantageous embodiment form of the invention, instead of a motion measurement device or a power measurement device, an RPM measurement device is provided to determine the RPM of the electric motor that rotates the eccentric weight inside the vibration flask. The change in the value of the RPM is processed by the evaluation circuit and is applied as a criterion for a densification effect or a densification result. In this way, the current densification state or at least the maximum attainable relative concrete density can be signaled to the operator.

Investigations have shown that when densifying concrete over time, a significant change in motor RPM occurs. The motor RPM falls after submerging the vibration flask into the fresh concrete at first, and then increases again with increasing concrete density. The power consumption of the motor behaves in the reverse fashion. The evaluation algorithms in the evaluation circuit 10 can thus be designed so that they take into account at least two parameters, namely the RPM and the time from submergence. After a certain time elapses and after attaining a prescribed RPM, the conclusion can be drawn that the concrete has been sufficiently densified.

This invention provides a sensitive poker vibrator that makes it possible to determine reactions of the vibration flask that result from a change in the texture of the fresh concrete and thus due to the densification activity. This makes it possible to provide to the operator independent of his knowledge and experience information as to the success of his work with the densification of concrete. This prevents to a large extent the occurrence of insufficient concrete quality due to low-quality densification work, for example by an untrained operator.

What is claimed is:

1. A poker vibrator for consolidating a plastic material to a desired density using a flask that has been introduced into the plastic material, comprising:
means for determining acceleration of the flask in a first direction during vibration of the flask;
means for determining acceleration of the flask in a second direction generally transverse to the first direction during vibration of the flask;
means for comparing the determined accelerations to a power communicated to an eccentric weight; and
means for determining a density of the plastic material from the comparison.

2. The poker vibrator of claim 1, wherein each of the acceleration determining means includes an accelerometer, and wherein the accelerometers are oriented generally transverse to one another and contained in a housing.

3. The poker vibrator of claim 1, further a powering means for generating power and means for adjusting an operating frequency generated by the powering means before power is communicated to the eccentric weight.

4. The poker vibrator of claim 3, further comprising a switch housing enclosing the operating frequency adjusting means.

5. The poker vibrator of claim 1, further comprising means for outputting a signal to an operator when the determined density approximates a desired density during generally continuous operation of the poker vibrator.

6. The poker vibrator of claim 5, wherein the outputting means generates at least one of an optical signal, an audible signal, and a tactile signal that is output on the poker vibrator proximate an operator during use.

7. A poker vibrator for adjusting a density of a plastic material to a desired value using an eccentric weight housed in a flask, the poker vibrator comprising:
means for driving the eccentric weight with an electric motor to vibrate the flask;
means for vibrating the plastic material with the vibrating flask to densify the plastic material;
means for assessing acceleration characteristics of the flask relative to the material; and
means for comparing the assessed acceleration characteristics to an operating characteristic of the electric motor to determine the density of the plastic material.

8. A method of adjusting a density of a plastic material to a desired value using an eccentric weight housed in a flask of a poker vibrator, the method comprising:
driving the eccentric weight with an electric motor to vibrate the flask;
vibrating the plastic material with the vibrating flask to densify the plastic material;
assessing acceleration characteristics of the flask relative to the material; and
comparing the assessed acceleration characteristics to an operating characteristic of the electric motor to determine the density of the plastic material.

9. The method of claim 8, further comprising assessing acceleration characteristics of the flask relative to the plastic material in a plurality of directions.

10. The method of claim 9, further comprising orienting the plurality of directions generally transverse to one another and generally transverse to a longitudinal axis of the flask.

11. The method of claim 8, further comprising monitoring one of motion of the eccentric weight, an amplitude of motion of the eccentric weight, a frequency of motion of the eccentric weight, a power consumption of the electric motor, an electrical excitation frequency of the electric motor, and a temperature of a winding of the electric motor.

12. The method of claim 8, further comprising providing an indication of the determined density.

13. The method of claim 12, wherein the indication is provided when the determined density approximates a preset density.

14. The method of claim 12, wherein the indication is at least one of visual, audio, and tactile.

15. The method of claim 8, further comprising adjusting an operating frequency of the electric motor based on the determined density.

16. The method of claim 15, wherein the electric motor is slowed when the determined density approaches a preset.

17. A method of consolidating a plastic material to a desired density using a flask of a poker vibrator that has been introduced into the plastic material comprising:
determining acceleration of the flask in a first direction during vibration of the flask;
determining acceleration of the flask in a second direction generally transverse to the first direction during vibration of the flask;
comparing the determined accelerations to a power communicated to an eccentric weight;
determining a density of the plastic material from the comparison.

18. The method of claim 17, further comprising:
outputting a signal to an operator when the determined density approximates the desired density during generally continuous operation of the poker vibrator.

19. The method of claim 18, wherein the signal is at least one of an audible signal and an optical signal.

20. The method of claim 17, wherein the accelerations are determined by a pair of accelerometers contained in the flask.

21. The method of claim 17, further comprising manipulating the power communicated to the eccentric weight based on the determined density.

22. The method of claim 17, further comprising storing at least one consolidation map that associates properties of the plastic material, operation of the eccentric weight, and flask acceleration data.
